(19) United States
(12) Patent Application Publication
(10) Pub. No.: US 2006/0278474 A1
(43) Pub. Date: Dec. 14, 2006

(54) Apparatus and method for leveling a ladder

(76) Inventor: Bobby G. Cumbie, Newnan, GA (US)

Correspondence Address: GEORGE R. REARDON, 3356 STATION COURT, LAWRENCVILLE, GA, 30044, US

(21) Appl. No.: 11/150,935

(22) Filed: Jun. 13, 2005

(51) Int. Cl. E06C 5/04

(52) U.S. Cl. 182/207

(57) ABSTRACT

The present invention provides an extension ladder leveling apparatus and a method of constructing and using a leveling extension ladder. Inward facing leveling means are used to minimized accidents and to facilitate rapid leveling of the extension ladder

### BACKGROUND OF THE INVENTION

This invention relates generally to ladder levelers and more specifically to an improved apparatus for leveling an extension ladder and a method of converting an extension ladder into a leveling ladder.

Extension ladders that have a top section which slides relative to a bottom section are well known. These ladders are generally formed from extruded aluminum and have side-rails made with channel sections that provide interlocking engagement between the top and bottom ladder sections. Such interlock arrangement usually extends the entire length of the extension ladder. During the course of using an extension ladder, the need often arises to employ the extension ladder on a sloping or uneven surface. For example, when leaning the ladder against the outside of a house, the ground is rarely level. Typically, a block or stack of blocks is placed on the ground and beneath one, or both, of the ladder legs in order to compensate for the different elevation of the ground and keep the extension ladder stable. Identical problems are also encountered in many other instances in which an extension ladder is used on an uneven or inclined surface.

As can be readily appreciated, the use of blocks and the like under a ladder leads to unsafe conditions and is often the cause of serious injury, particularly since it is not uncommon for bricks, pieces of wood and other makeshift items to be employed as leveling devices. Consequently, a need exists for a ladder which is capable of standing uprightly on uneven or inclined surfaces. It is the primary goal of the present invention to meet that need.

Previous attempts to provide for the leveling of ladders include:
U.S. Pat. No. 6,729,440, issued to Bailey, discloses a step ladder for uneven surfaces, having a mechanism fixed to bottom end of each of the four legs for locking each adjustable leg at preset height and including holes evenly spaced out along each leg with bottom mounted pads that are non-skid surfaces. The locking means is a spring-loaded pin located on the outside of each leg.
U.S. Pat. No. 5,497,850, issued to Patterson, discloses an apparatus for leveling a ladder on uneven surfaces comprised of legs for fitting into the hollow side rails that are fastened through support holes using bolts.
U.S. Pat. No. 5,273,133, issued to Thocher, discloses a ladder leveler. The invention consists of a mechanical gear system and extension member. Upon manually rotating the gear mechanism, the side member will extend or retract according to the direction of the rotation. A means for locking the gear system in place is provided.
U.S. Pat. No. 5,232,067, issued to Griffith, discloses a stile extending attachment for a ladder. The invention consists of an attachment device for use on a ladder having hollow rungs and two side stile members. A long bolt is inserted through two of the hollow rungs and extends from one side stile through to the other and through the attachment device. The attachment device is releasably fastened by a nut and washer at each of the through bolts, thereby allowing the adjustment of the length of one of the two side stile members of the ladder.
U.S. Pat. No. 5,107,958, issued to Johnson, discloses a ladder leveler. The invention consists of a pair of leg extensions that are releasably affixed to the end of the side rails of the ladder. The extensions have a tightening bolt and a tension spring to secure the extension at a desired height. The extensions shown, fit over the end of the side rails and can be affixed thereto with screws or the like.
U.S. Pat. No. 4,091,893, issued to Neal, discloses a ladder with adjustable legs for use on uneven surfaces.
U.S. Pat. No. 3,948,352, issued to Larson, discloses an extension ladder formed of interlocked top and bottom sections having ladder leveler means comprising a pair of sleeve members that slideably encompass the lower end of the bottom section side-rails. A short flange on each sleeve member is captivated by a guide member carried on the inside of each lower side-rail permitting the sleeve members to be securely retained in operative position on the bottom of the ladder without interference with the free sliding of the ladder top section along the bottom section. The secure retaining is accomplished by a spring-biased pin.
U.S. Pat. No. 2,936,849, issued to Larson, discloses a ladder with adjustable legs for use on uneven surfaces.

While these patents and other previous methods have attempted to solve the problem of leveling ladders, none have employed a kit that utilizes the bottom rung and pivot feet of an existing extension ladder in order to form a leveling extension ladder from an existing extension ladder. Additionally, none have employed inward facing spring loaded pull pin assemblies for quick leveling and reduced footprint.

Therefore, a need exists for an improved apparatus and method for leveling extension ladders.

The foregoing patent and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

The present invention provides an apparatus and method of constructing a leveling extension ladder whereby the extension ladder leveling apparatus is comprised of a left rectangular tube assembly, a right rectangular tube assembly, a left extension leg assembly, a right extension leg assembly and a rung assembly. The right extension leg assembly slides into the right rectangular tube assembly and is releasably secured by a pin through a hole in the inward side of the right rectangular tube assembly to an internal slot within the right extension leg assembly. The left extension leg assembly slides into the left rectangular tube assembly and is releasably secured by a pin through a hole in the inward side of the left rectangular tube assembly to an internal slot within the left extension leg assembly. The rung in the rung assembly originates from the bottom rung of an existing extension ladder, is removed from the existing ladder and is shortened prior to becoming part of the rung assembly. The rung assembly is permanently affixed to the two rectangular tube assemblies so that the left rectangular tube assembly and the right rectangular tube assembly are parallel to each other, with the left means for adjusting the leg length of the left extension leg facing the right means for adjusting the leg length of the right extension leg. The assembly of these elements forms the extension ladder leveling apparatus. The extension ladder leveling apparatus is then permanently affixed to an extension ladder such that the rung assembly is in the same location as the bottom rung that was previously removed, thus forming a leveling extension ladder.

It is therefore an object of the present invention to provide an extension ladder leveler which has all of the advantages of the prior art and none of the disadvantages.

It is an object of the present invention to provide an extension ladder leveler that is easily and accurately adjusted.

It is an object of the present invention to provide an extension ladder leveler that can be installed on any ladder having hollow side rails.

It is another object of the present invention to provide an extension ladder leveler which may be easily and efficiently manufactured and marketed.

It is another object of the present invention to provide an extension ladder leveler which is of durable and reliable construction.

It is yet another object of the present invention to provide an extension ladder leveler which is economically affordable and available for the relevant market segments of the purchasing public.

Another objective of the present invention is to provide an extension ladder leveler that is easy to use.

Another objective of the present invention is to provide an extension ladder leveler that can be reused many times.

Another objective of the present invention is to provide an assembly process for making the invention which uses readily available materials and components.

Another objective of the present invention is to provide a method for using the invention that is easy to learn.

Additional objects and advantages of the invention will be set forth in part in the description which follows, and in part will be obvious from the description, or may be learned by practice of the invention. The objects and advantages of the invention will be obtained by means of instrumentalities in combinations particularly pointed out in the appended claims.

There has thus been outlined, rather broadly, the more important features of a ladder that the detailed description thereof that follows may be better understood and in order that the present contribution to the art may be better appreciated. There are, of course, additional features of the ladder that will be described hereinafter and which will form the subject matter of the claims appended hereto.

In this respect, before explaining at least one embodiment of the ladder in detail, it is to be understood that the ladder is not limited in its application to the details of construction and to the arrangements of the components set forth in the following description or illustrated in the drawings. The ladder is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present ladder. It is important, therefore, that the claims be regarded as including such equivalent constructions insofar as they do not depart from the spirit and scope of the present invention.

### BRIEF DESCRIPTION OF THE SEVERAL VIEWS OF THE DRAWING

The accompanying drawings illustrate a complete embodiment of the invention according to the best modes so far devised for the practical application of the principles thereof, and in which:

FIG. 1 is a front plan view of related art.

FIG. 2 is a left side plan view of related art.

FIG. 3 is a leftt side plan view of a leveling extension ladder according to a preferred embodiment of the invention.

FIG. 4 is a front plan view and right side plan view of a leveling extension ladder according to a preferred embodiment of the invention.

FIG. 5 is a front plan view and right side plan view of a right rectangular tube apparatus according to a preferred embodiment of the invention.

FIG. 6 is a front plan view and right side plan view of a right extension leg apparatus according to a preferred embodiment of the invention.

FIG. 7 is a front plan view and right side plan view of a left extension leg apparatus installed within a left rectangular tube apparatus according to a preferred embodiment of the invention.

FIG. 8 is a partial front plan view of an adjustable extension ladder showing the extension ladder leveling apparatus installed in an extension ladder according to a preferred embodiment of the invention.

### DETAILED DESCRIPTION OF THE INVENTION

The present invention is comprised of left rectangular tube assembly 2L, right rectangular tube assembly 2R, left extension leg assembly 3L, right extension leg assembly 3R and rung assembly 5. Right extension leg assembly 3R slides into right rectangular tube assembly 2R and is releasably secured by dowel pin 090 through hole-dowel pin 100 in the inward side of right rectangular tube assembly 2R to slot 080 within right extension leg assembly 3R. Left extension leg assembly 3L slides into left rectangular tube assembly 2L and is releasably secured by dowel pin 090 through hole-dowel pin 100 in the inward side of left rectangular tube assembly 2L to slot 080 within left extension leg assembly 3L. Rung 140 in rung assembly 4 originates from the bottom rung of ladder 170, is removed from ladder 170 and is shortened prior to becoming part of rung assembly 4. Rung assembly 4 is permanently affixed to the two rectangular tube assemblies so that left rectangular tube assembly 2L and right rectangular tube assembly 2R are parallel to each other, with spring loaded pull pin assembly 070 for adjusting the leg length of left extension leg 040 facing spring loaded pull pin assembly 070 for adjusting the leg length of right extension leg 030. The assembly of these elements forms extension ladder leveling apparatus 1. Extension ladder leveling apparatus 1 is then permanently affixed to extension ladder 170 such that the rung portion of rung assembly 4 is in the same location as the bottom rung that was previously removed, thus forming leveling extension ladder 180.

Left rectangular tube assembly 2L is comprised of left rectangular tube 020, slot 080 formed in left rectangular tube 020, hole-spring loaded assembly 130 formed in left rectangular tube 020, and spring loaded pull pin assembly 070 permanently affixed to left rectangular tube 020.

Right rectangular tube assembly 2R is comprised of right rectangular tube 030, slot 080 formed in right rectangular tube 030, hole-spring loaded assembly 130 formed in right rectangular tube 030, and spring loaded pull pin assembly 070 permanently affixed to right rectangular tube 030.

Left extension leg assembly 3L is comprised of left extension leg 040, hole-dowel pin 100, a plurality of hole-leg adjustment 110 formed in left extension leg 040, hole-foot 120 formed in left extension leg 040, pivot foot 150, bolt 160 that is releaseably attached to pivot foot 150 using hole-foot 120, and extension leg end cap 050 that is permanently affixed to the ground end of left extension leg 040.

Right extension leg assembly 3R is comprised of right extension leg 030, hole-dowel pin 100, a plurality of hole-leg adjustment 110 formed in right extension leg 030, hole-foot 120 formed in right extension leg 030, pivot foot 150, bolt 160 that is releaseably attached to pivot foot 150 using hole-foot 120, and extension leg end cap 050 that is permanently affixed to the ground end of right extension leg 030.

Rung assembly 5 is comprised of rung 140 and two socket for ladder rung 060, each of which is permanently affixed to each end of rung 140.

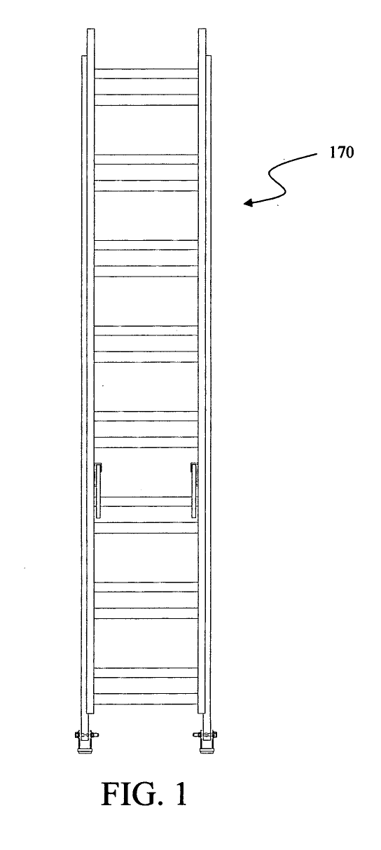

Referring now to FIG. 1, ladder 170 is shown from a front plan view. In the preferred embodiment, ladder 170 is a Werner 16 ft. Extension Ladder.

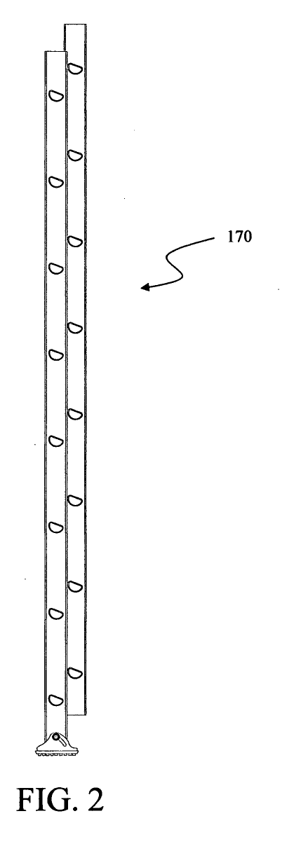

Referring now to FIG. 2, ladder 170 is shown from a left side plan view.

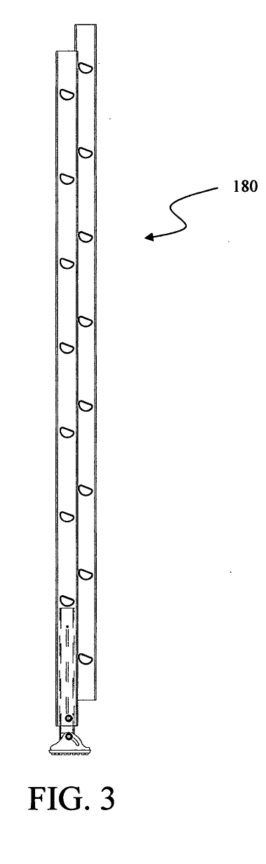

Referring now to FIG. 3, leveling ladder 180 is shown from a left side plan view.

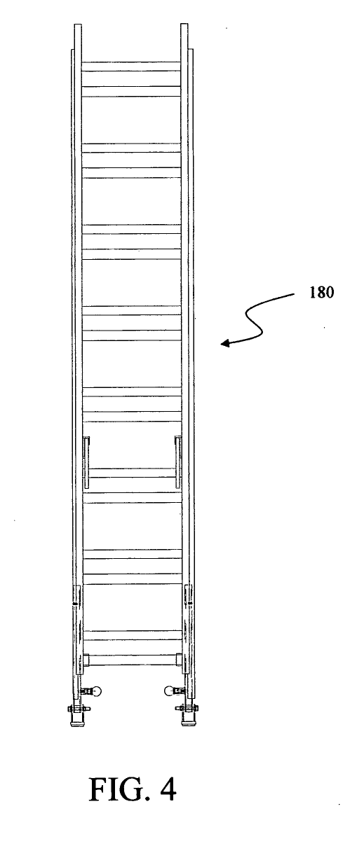

Referring now to FIG. 4, leveling ladder 180 is shown from a front plan view.

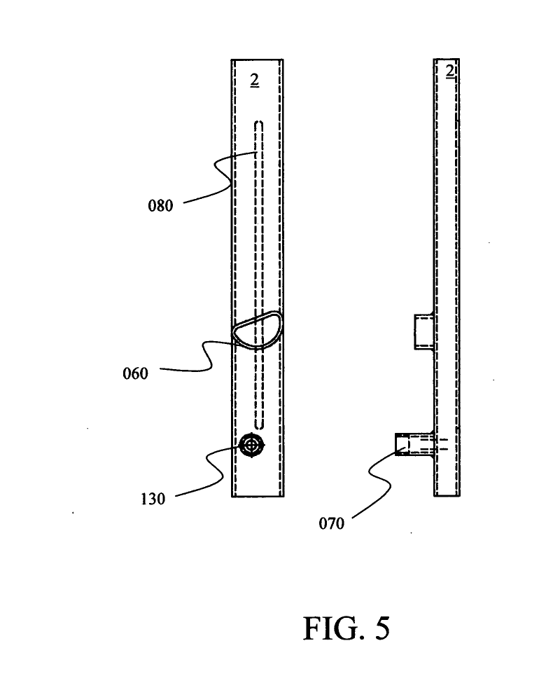

Referring now to FIG. 5, right rectangular tube assembly 2 is shown, as well as socket or ladder rung 060, spring loaded pull pin assembly 070, slot 080 and hole-spring loaded assembly 130.

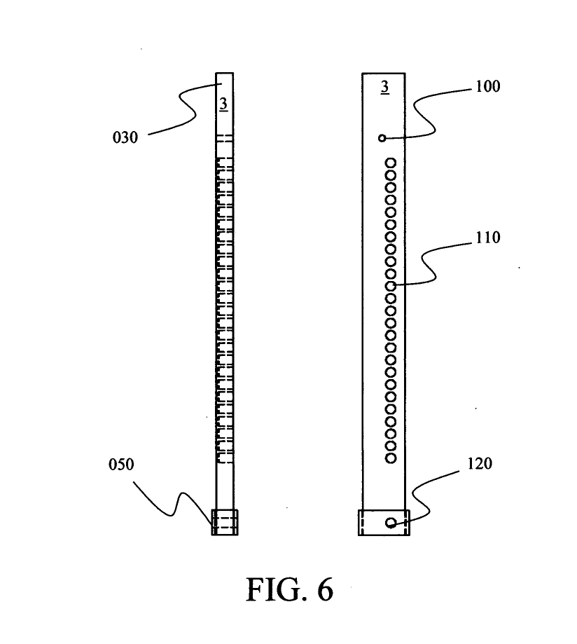

Referring now to FIG. 6, right extension leg assembly 3 is shown, as well as right extension leg 030, extension leg end cap 050, hole-dowel pin 100, hole-leg adjustment 110 and hole-foot 120.

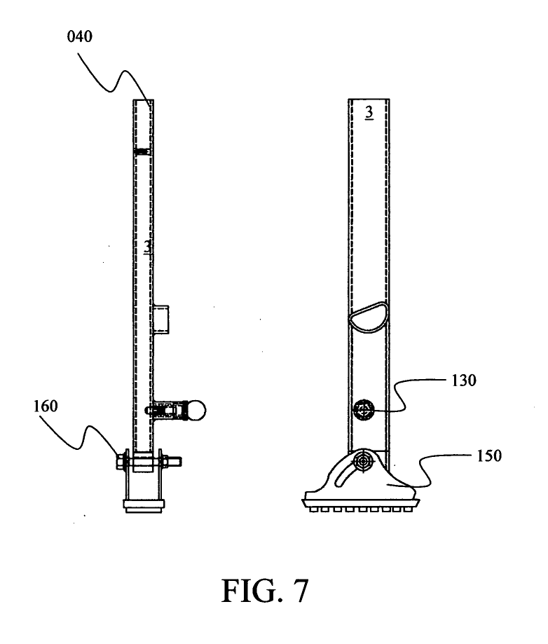

Referring now to FIG. 7, left extension tube-leg assembly 4 is shown, with left extension leg 040 being within left rectangular tube 020, left extension leg 040, hole-spring loaded assembly 130, bolt 160 and pivot foot 150.

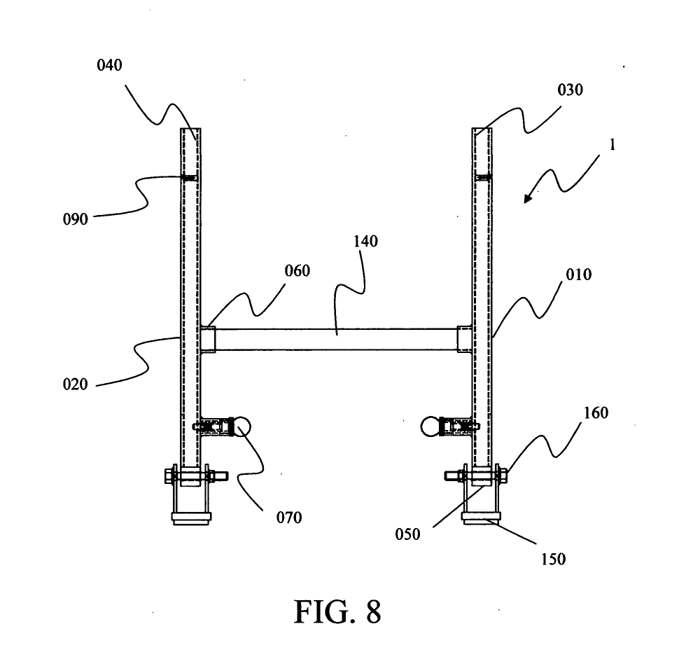

Referring now to FIG. 8, extension ladder leveler assembly 1 is shown, as well as right rectangular tube 010, left rectangular tube 020, right extension leg 030, left extension leg 040, extension leg end cap 050, socket for ladder rung 060, spring loaded pull pin assembly 070, rung 140, pivot foot 150 and bolt 160.

The preferred embodiment of the present invention is made as follows:
1) Obtaining ladder 170;
2) Laying ladder 170 back across two sawhorses;
3) Sliding the bottom extension of ladder 170 approximately three feet out to allow room to work on the bottom portion of ladder 170;
4) Removing rung 140 from ladder 170;
5) Laying aside rung 140;
6) Removing bolt 160 and pivot foot 150 from each bottom end of ladder 170;
7) Sliding extension leg end cap 050 flush with the end of right extension leg 030;
8) Welding extension leg end cap 050 to the end of right extension leg 030;
9) Sliding extension leg end cap 050 flush with the end of left extension leg 040;
10) Welding extension leg end cap 050 to the end of left extension leg 040;
11) Sliding left extension leg 040 inside left rectangular tube 020 until hole-dowel pin 100 is aligned with slot 080;
12) Installing dowel pin 090 through hole-dowel pin 100 and in slot 080;
13) Sliding right extension leg 030 inside right rectangular tube 010 until hole-dowel pin 100 is aligned with slot 080;
14) Installing dowel pin 090 through hole-dowel pin 100 and in slot 080;
15) Installing spring loaded pull pin assembly 070 into right rectangular tube 010;
16) Welding spring loaded pull pin assembly 070 to right rectangular tube 010;
17) Welding socket for ladder rung 060 to left rectangular tube 020;
18) Welding socket for ladder rung 060 to right rectangular tube 010;
19) Installing pivot foot 150 to left leg extension 040 by using bolt 160;
20) Installing pivot foot 150 to right leg extension 030 by using bolt 160;
21) Measuring inside opening of ladder 170 to get a first measurement;
22) Deducting the combined thickness of left rectangular tube 020 and right rectangular tube 010 from the first measurement to get a second measurement;
23) Cutting rung 140 to the length of the second measurement;
24) welding rung 140 into socket for ladder rung 060 to complete the forming of extension ladder leveler assembly 1;
25) sliding extension ladder leveler assembly 1 inside the opening of ladder 170 until left rectangular tube 020 and right rectangular tube 010 stops at the position of the original second rung;
26) ensuring that extension ladder leveler assembly 1 is resting firmly on the rear lip of ladder 170; and
27) welding the extension ladder leveler assembly in place to ladder 170 to form leveling ladder 180.

The preferred method of using this embodiment of the invention is comprised of the following steps.
1) Placing leveling ladder 180 at the desired location such that at least one of pivot foot 150 touches the surface on which leveling ladder 180 is to rest;
2) Holding leveling ladder 180 in a substantially vertical position;
3) Pulling spring loaded pull pin assembly 070 for the extension leg needing extending;
4) Extending the extension leg associated with the spring loaded pull pin assembly 070 being pulled until leveling ladder 180 is supported in a substantially vertical position; and
5) Releasing spring loaded pull pin assembly 070 such that it engages hole-leg adjustment 110 securely.

Parts for the preferred embodiment of the invention are as follows:

| PART | | |
|---|---|---|
| NUMBER | PART NAME | SPECIFICATIONS |
| 010 | Right Rectangular Tube | ⅛″ × 1″ × 2″ Aluminum Tube |
| 020 | Left Rectangular Tube | ⅛″ × 1″ × 2″ Aluminum Tube |
| 030 | Right Extension Leg | 11/16″ × 1¾″ × 18¾″ Aluminum |
| | | Bar |
| 040 | Left Extension Leg | 11/16″ × 1¾″ × 18¾″ |
| | | Aluminum Bar |
| 050 | Extension Leg End Cap | ⅛″ × 1″ × 2″ Aluminum |
| 060 | Socket For Ladder Rung | ⅛″ × ¾″ Aluminum |
| 070 | Spring Loaded Pull Pin | ⅜″ Weld-In Quick Pin Type |
| | Assembly | |
| 080 | Slot | 5/16″ × 12¼″ |
| 090 | Dowel Pin | ¼″ × ¾″ |
| 100 | Hole-Dowel Pin | ¼″ Hole for Dowel Pin |
| 110 | Hole-Leg Adjustment | 7/16″ Hole for Leg Adjustment |
| 120 | Hole-Foot | 7/16″ Hole for Foot |
| 130 | Hole-Spring Loaded | 7/16″ Hole for Installing Spring |
| | Assembly | Loaded Assembly |
| 140 | Rung | Rung Removed from Werner |
| | | Ladder Cut & Reinstalled |
| 150 | Pivot Foot | Pivot Foot with Rubber Tread |
| 160 | Bolt | 5/16″ × 2½″ Bolt |
| 170 | Ladder | Werner 16 ft. Extension Ladder |

What is claimed is:

1. A method of converting an extension ladder into an extension leveling ladder comprising:
a) obtaining said extension ladder with a bottom rung and two pivot feet secured with two bolts disposed at the bottom end of said extension ladder;
b) laying said extension ladder back across two sawhorses;
c) sliding the bottom extension of said extension ladder approximately three feet out to allow room to work on the bottom portion of said extension ladder;
d) removing the bottom rung from said extension ladder;
e) laying aside said bottom rung;
f) removing said two bolts and two pivot feet from said bottom end of said ladder and laying them aside;
g) sliding a first extension leg end cap flush with the end of a right extension leg;
h) welding said first extension leg end cap to the end of said right extension leg;
i) sliding a second extension leg end cap flush with the end of said left extension leg;
j) welding said second extension leg end cap to the end of said left extension leg;
k) sliding said left extension leg inside a left rectangular tube;
l) installing a first dowel pin into a first slot;
m) sliding said right extension leg inside a right rectangular tube;
n) installing a second dowel pin into a second slot;
o) installing a spring loaded pull pin assembly into said right rectangular tube;
p) welding said spring loaded pull pin assembly to said right rectangular tube;
q) welding a first socket for said ladder rung to said left rectangular tube;
r) welding a second socket for said ladder rung to said right rectangular tube;
s) installing a first pivot foot to said left leg extension by using a first bolt;
t) installing a second pivot foot to said right leg extension by using a second bolt;
u) measuring inside opening of said extension ladder to get a first measurement;
v) deducting the combined thickness of said left rectangular tube and said right rectangular tube from said first measurement to get a second measurement;
w) cutting bottom rung to the length of said second measurement;
x) welding said bottom rung into said first socket and said second socket to complete the forming of extension ladder leveler assembly;
y) sliding said extension ladder leveler assembly inside the opening of said extension ladder until said left rectangular tube and said right rectangular tube stop at the position of the original second rung;
z) ensuring that said extension ladder leveler assembly is resting firmly on the rear lip of extension ladder; and
aa) welding said extension ladder leveler assembly in place to form a leveling ladder.

2. An extension ladder leveling apparatus comprised of:
a) A left rectangular tube assembly;
b) A right rectangular tube assembly;
c) a left extension leg assembly;
d) a right extension leg assembly; and
e) a rung assembly.

3. The extension ladder leveling apparatus of claim 2
a) wherein said left rectangular tube assembly is comprised of a left rectangular tube, a slot formed in said left rectangular tube, a spring loaded assembly hole formed in said left rectangular tube and a spring loaded pull pin assembly permanently affixed to said left rectangular tube,
b) wherein said right rectangular tube assembly is comprised of a right rectangular tube, a slot formed in said right rectangular tube, a spring loaded assembly hole formed in said right rectangular tube, and a spring loaded pull pin assembly permanently affixed to said right rectangular tube,
c) wherein said left extension leg assembly is comprised of a left extension leg, a dowel pin hole, a plurality of leg adjustment holes formed in said left extension leg, a foot hole formed in said left extension leg, a pivot foot, a bolt that is releasably attached to said pivot foot using said foot hole, and an extension leg end cap that is permanently affixed to the ground end of said left extension leg,
d) wherein said right extension leg assembly is comprised of a right extension leg, a dowel pin hole, a plurality of leg adjustment holes formed in said right extension leg, a foot hole formed in said right extension leg, a pivot foot, a bolt that is releasably attached to said pivot foot using said foot hole, and an extension leg end cap that is permanently affixed to the ground end of said right extension leg,
e) wherein said rung assembly is comprised of a rung and two sockets for said rung, each of which is permanently affixed to each end of said rung.
